(19) United States
(12) Patent Application Publication
(10) Pub. No.: US 2014/0327948 A1
(43) Pub. Date: Nov. 6, 2014

(54) DISPLAY ELEMENTS INCORPORATING ASYMMETRIC APERTURES

(71) Applicant: PIXTRONIX, INC., San Diego, CA (US)

(72) Inventors: Jianru Shi, Haverhill, MA (US); Xiang-Dong Mi, Northborough, MA (US); Jignesh Gandhi, Burlington, MA (US)

(73) Assignee: Pixtronix, Inc., San Diego, CA (US)

(21) Appl. No.: 13/888,022

(22) Filed: May 6, 2013

(51) Int. Cl. G02B 26/02

(52) U.S. Cl. CPC G02B 26/02
USPC 359/230; 29/428

(57) ABSTRACT

This, disclosure provides systems, methods and apparatus for improving the angular light distribution of a display apparatus. Smaller shutter-based display apparatus that modulate light passing through at least two apertures in an aperture or light blocking layer can provide similar viewing angle characteristics as larger shutter-based modulators by disproportionately reducing the width of a subset of the at least two apertures in relation to the remainder of the apertures. As the width of such apertures is one of the primary determinants of viewing angle, allowing a greater percentage of the light throughput of a shutter assembly to pass through wider apertures helps maintain a wider viewing angle for the display.

### TECHNICAL FIELD

This disclosure relates to the field of imaging displays, and in particular to pixels of imaging displays.

### DESCRIPTION OF THE RELATED TECHNOLOGY

Shutter-based light modulators have been demonstrated for use in displays. Such light modulators operate by selectively blocking apertures formed in a light blocking layer positioned in front of a backlight. Given demand for increased display resolutions, measured in pixels-per-inch (PPI), there is added pressure to reduce the size of such shutter-based light modulators, along with the size of their corresponding apertures. Particularly with apertures having oblong shapes, such as rectangles, reducing the size of the apertures' shorter dimension can adversely impact the viewing angle of the display.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus having an electromechanical systems (EMS) display element. The EMS display element can include a light blocking layer defining at least first and second light blocking layer apertures, such that the first light blocking layer aperture has at least one dimension that is at least about 25% larger than a corresponding dimension of the second light blocking layer aperture. The EMS display can also include a light obstructing component supported over the light blocking layer configured to move between a light blocking state and a light transmissive state to selectively block the passage of light through the first and second light blocking layer apertures.

In some implementations, the light obstructing component defines a light obstructing component aperture such that when the light obstructing component is in the light transmissive state, the light obstructing component aperture substantially aligns with at least one of the first and second light blocking layer apertures.

In some other implementations, the light blocking layer defines at least a third light blocking layer aperture and the light obstructing component is configured, in the light blocking state, to block the passage of light through the at least third light blocking layer aperture. In some implementations, the at least third light blocking layer aperture has dimensions substantially the same as the first light blocking layer aperture. In some other implementations, the first, second and at least third light blocking layer apertures are arranged substantially in a line along an axis of motion of the light obstructing component and the second light blocking layer aperture is positioned at one end of the line.

In some implementations, the at least one dimension of the first light blocking layer aperture that is at least 25% larger than the corresponding dimension of the second light blocking layer aperture is a dimension along the axis of motion of the light obstructing component. In some other implementations, the at least one dimension of the first light blocking layer aperture is about 100% larger than the corresponding dimension of the second light blocking layer aperture.

In some implementations, the apparatus can further include a display including the EMS display element, a processor that is configured to communicate with the display, the processor being configured to process image data, and a memory device that is configured to communicate with the processor. In some such implementations, the display can further include a driver circuit configured to send at least one signal to the display, and a controller configured to send at least a portion of the image data to the driver circuit.

In some implementations, the display can further include an image source module configured to send the image data to the processor, where the image source module includes at least one of a receiver, transceiver, and transmitter. In some other implementations, the display further includes an input device configured to receive input data and to communicate the input data to the processor.

Another innovative aspect of the subject matter described in this disclosure can be implemented in a method for forming a display apparatus, where the method includes forming a light blocking layer on a substrate having a first aperture and a second aperture such that the first aperture has at least one dimension that is at least about 25% larger than a corresponding dimension of the second aperture. The method can further include forming a movable light obstructing component configured to move between a light blocking state and a light transmissive state to selectively block the passage of light through the first and second apertures.

In some implementations, forming the movable light obstructing component includes defining a light obstructing component aperture such that when the light obstructing component is in the light transmissive state, the light obstructing component aperture substantially aligns with at least one of the first and second apertures. In some other implementations, forming the light blocking layer further includes forming a third aperture having dimensions substantially the same as the dimensions of the first aperture. In some other implementations, forming the light blocking layer further includes arranging the first, second and the third aperture substantially in a line along an axis of motion of the light obstructing component.

In some implementations, forming the light blocking layer further includes forming the first and the second apertures such that at least one dimension of the first aperture that is along the axis of motion of the light obstructing component is at least 25% larger than the corresponding dimension of the second aperture. In some other implementations, forming the light blocking layer further includes forming the first and second apertures such that the dimensions of the first aperture are 100% larger than the corresponding dimensions of the second aperture.

Details of one or more implementations of the subject matter described in this specification are set forth in the accompanying drawings and the description below. Although the examples provided in this summary are primarily described in terms of electromechanical systems (EMS) based displays, the concepts provided herein may apply to other types of displays, such as liquid crystal displays (LCD), organic light-emitting diode (OLED) displays, electrophoretic displays, and field emission displays, as well as to other non-display EMS devices, such as EMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIGS. 3-5B show various views of example display apparatus.

FIG. 6 shows a flow diagram of an example process for forming a display apparatus having asymmetrical apertures.

FIGS. 7A and 7B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (for example, e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Smaller shutter-based light modulators that modulate light passing through at least two apertures in an aperture or light blocking layer can provide similar viewing angle characteristics as larger shutter-based modulators by disproportionately reducing the width of a subset of the at least two apertures in relation to the remainder of the apertures. As the width of the apertures is one of the primary determinants of viewing angle, allowing a greater percentage of the light throughput of a shutter assembly to pass through wider apertures helps maintain a wider viewing angle for the display.

Particular implementations of the subject matter described in this disclosure can be implemented to realize one or more of the following potential advantages. By having unequal sized, or asymmetric, apertures such that a greater percentage of light is passed through wider apertures than through narrower apertures, an overall viewing angle and/or the angular light distribution of a display apparatus can be improved. Having asymmetric apertures reduces or avoids a reduction in the angular light distribution of a display device that may result from a reduction in the overall size of pixels in attempts to meet the demands of higher pixels-per-inch (PPI) displays.

In some implementations, appropriately placing apertures with smaller widths in relation to other apertures with greater widths can reduce a distance traveled by a shutter when switching between states. Reducing the distance traveled by the shutter can reduce operating voltages of the shutter and increase the speed of operation of the shutter. In some implementations, the asymmetric configuration of the apertures provides improved light blocking characteristics when the shutter is in the closed state.

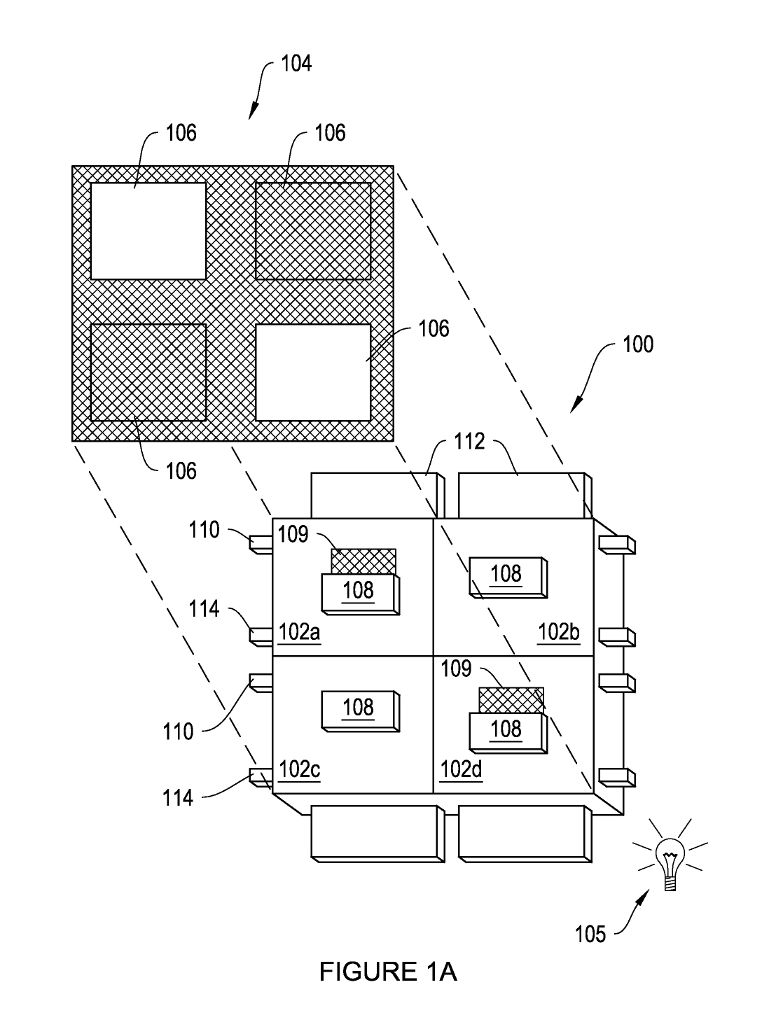

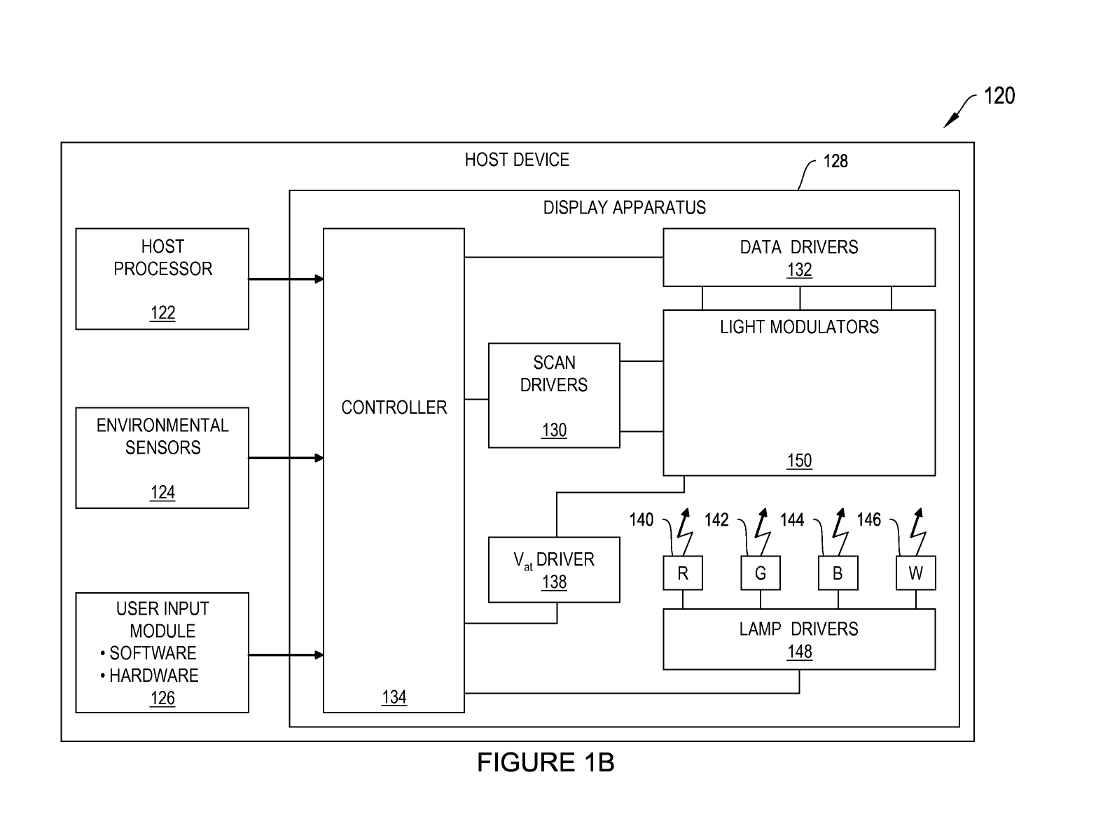

FIG. 1A shows a schematic diagram of an example direct-view MEMS-based display apparatus 100. The display apparatus 100 includes a plurality of light modulators 102a-102d (generally “light modulators 102”) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (such as interconnects 110, 112 and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{WE}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows a block diagram of an example host device 120 (i.e., cell phone, smart phone, PDA, MP3 player, tablet, e-reader, netbook, notebook, etc.). The host device 120 includes a display apparatus 128, a host processor 122, environmental sensors 124, a user input module 126, and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146, lamp drivers 148 and an array 150 of display elements, such as the light modulators 102 shown in FIG. 1A. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the array 150 of display elements, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in sequences, which in some implementations may be predetermined, grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 114. In some other implementations, the common drivers 138, following commands from the controller 134, issue voltage pulses or signals to the array 150 of display elements, for instance global actuation pulses which are capable of driving and/or initiating simultaneous actuation of all display elements in multiple rows and columns of the array 150.

All of the drivers (such as scan drivers 130, data drivers 132 and common drivers 138) for different display functions are time-synchronized by the controller 134. Timing commands from the controller coordinate the illumination of red, green and blue and white lamps (140, 142, 144 and 146 respectively) via lamp drivers 148, the write-enabling and sequencing of specific rows within the array 150 of display elements, the output of voltages from the data drivers 132, and the output of voltages that provide for display element actuation. In some implementations, the lamps are light emitting diodes (LEDs).

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz (Hz). In some implementations the setting of an image frame to the array 150 is synchronized with the illumination of the lamps 140, 142, 144 and 146 such that alternate image frames are illuminated with an alternating series of colors, such as red, green, and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 134 forms an image by the method of time division gray scale, as previously described. In some other implementations, the display apparatus 100 can provide gray scale through the use of multiple shutters 108 per pixel.

In some implementations, the data for an image state 104 is loaded by the controller 134 to the display element array 150 by a sequential addressing of individual rows, also referred to as scan lines. For each row or scan line in the sequence, the scan driver 130 applies a write-enable voltage to the write enable interconnect 110 for that row of the array 150, and subsequently the data driver 132 supplies data voltages, corresponding to desired shutter states, for each column in the selected row. This process repeats until data has been loaded for all rows in the array 150. In some implementations, the sequence of selected rows for data loading is linear, proceeding from top to bottom in the array 150. In some other implementations, the sequence of selected rows is pseudo-randomized, in order to minimize visual artifacts. And in some other implementations the sequencing is organized by blocks, where, for a block, the data for only a certain fraction of the image state 104 is loaded to the array 150, for instance by addressing only every 5^{th} row of the array 150 in sequence.

In some implementations, the process for loading image data to the array 150 is separated in time from the process of actuating the display elements in the array 150. In these implementations, the display element array 150 may include data memory elements for each display element in the array 150 and the control matrix may include a global actuation interconnect for carrying trigger signals, from common driver 138, to initiate simultaneous actuation of shutters 108 according to data stored in the memory elements.

In alternative implementations, the array 150 of display elements and the control matrix that controls the display elements may be arranged in configurations other than rectangular rows and columns. For example, the display elements can be arranged in hexagonal arrays or curvilinear rows and columns. In general, as used herein, the term scan-line shall refer to any plurality of display elements that share a write-enabling interconnect.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module 126 is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device 120. The environmental sensor module 124 receives data about the ambient environment, such as temperature and or ambient lighting conditions. The sensor module 124 can be programmed to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

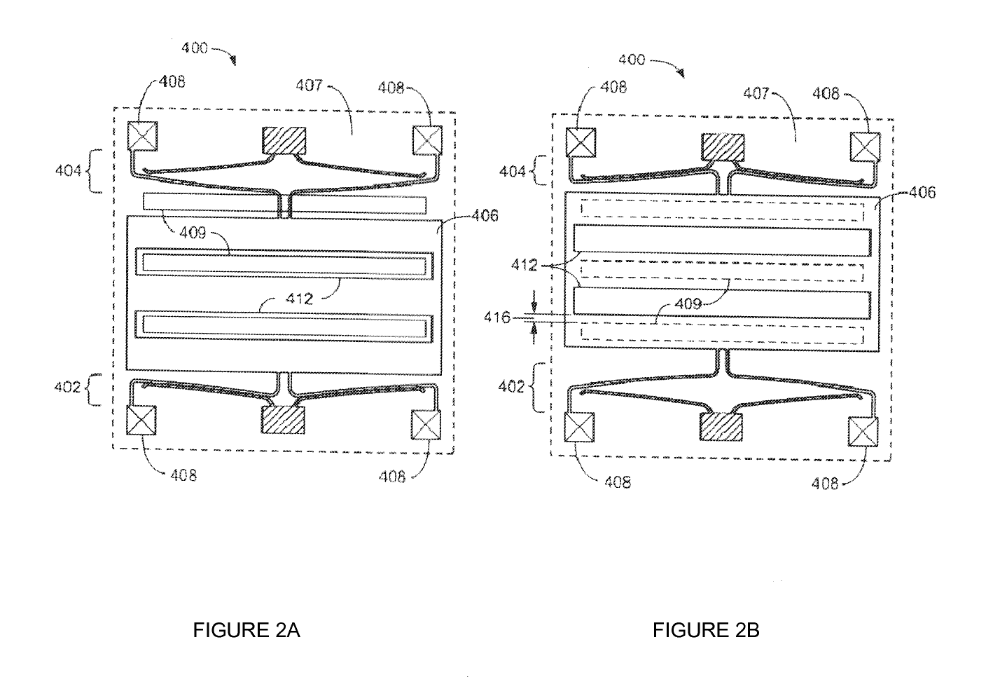

FIGS. 2A and 2B show views of an example shutter based light modulator 400. The light modulator (also referred to as “dual actuator shutter assembly”) 400 can include dual actuators for actuating a shutter. The dual actuator shutter assembly 400 can be suitable for incorporation into the direct view MEMS-based display apparatus 100 of FIG. 1A as the light modulator 102. The dual actuator shutter assembly 400, as depicted in FIG. 2A, is in an open state. FIG. 2B shows the dual actuator shutter assembly 400 in a closed state. In contrast to the shutter assembly 200, the shutter assembly 400 includes actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both of the actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of movement reduces out of plane motion of the shutter 406 and confines the motion substantially to a plane parallel to the substrate.

The shutter 406 includes two shutter apertures 412 through which light can pass. The aperture layer 407 includes a set of three apertures 409. In FIG. 2A, the shutter assembly 400 is in the open state and, as such, the shutter-open actuator 402 has been actuated, the shutter-close actuator 404 is in its relaxed position, and the centerlines of the shutter apertures 412 coincide with the centerlines of two of the aperture layer apertures 409. In FIG. 2B the shutter assembly 400 has been moved to the closed state and, as such, the shutter-open actuator 402 is in its relaxed position, the shutter-close actuator 404 has been actuated, and the light blocking portions of the shutter 406 are now in position to block transmission of light through the apertures 409 (depicted as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In some other implementations, the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through apertures 412 and 409 in the open state, it is advantageous to provide a width or size for shutter apertures 412 which is larger than a corresponding width or size of apertures 409 in the aperture layer 407. In order to effectively block light from escaping in the closed state, it is preferable that the light blocking portions of the shutter 406 overlap the apertures 409. FIG. 2B shows an overlap 416, which in some implementations can be predefined, between the edge of light blocking portions in the shutter 406 and one edge of the aperture 409 formed in the aperture layer 407.

The electrostatic actuators 402 and 404 are designed so that their voltage-displacement behavior provides a bi-stable characteristic to the shutter assembly 400. For each of the shutter-open and shutter-close actuators there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

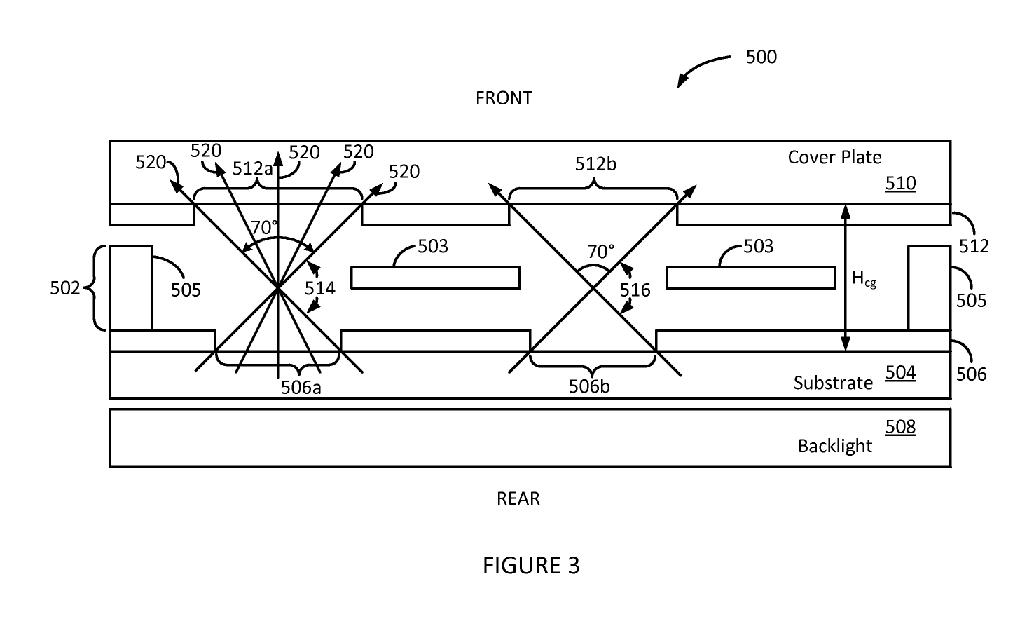

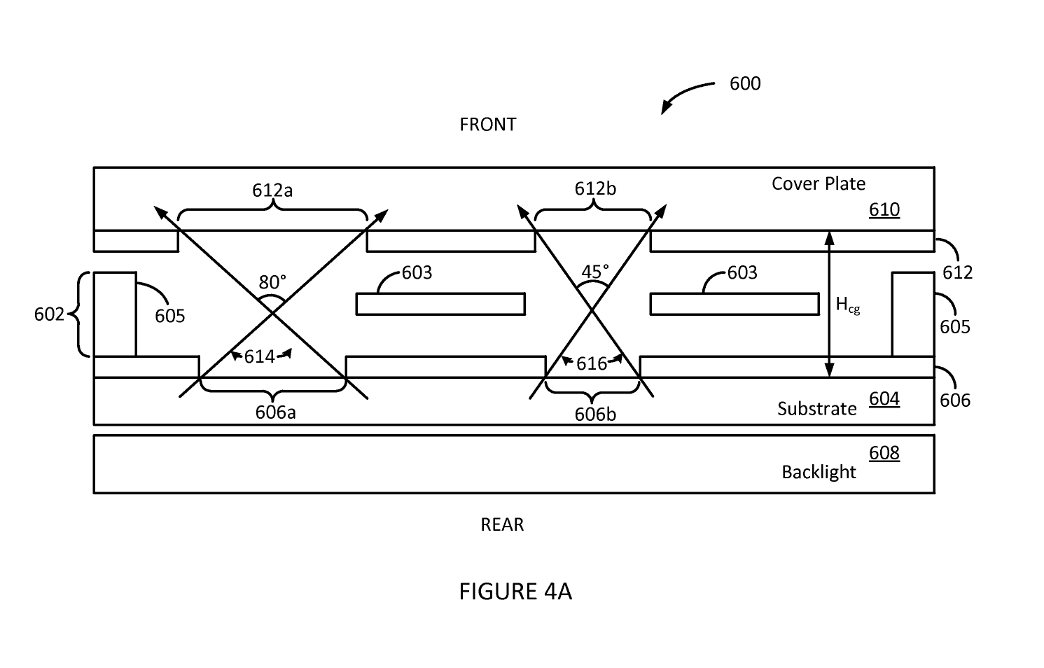

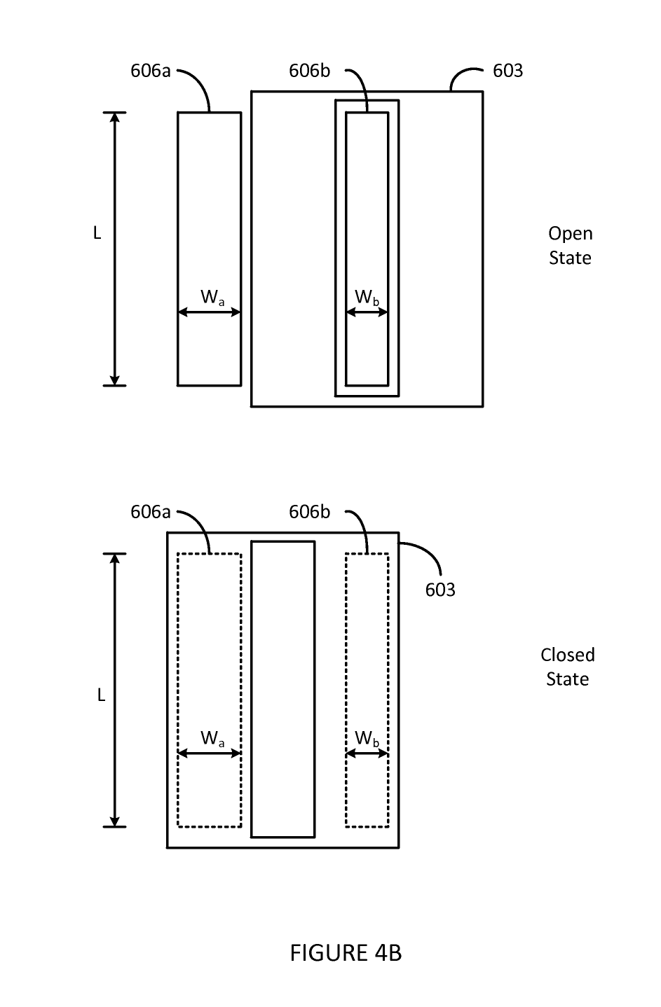

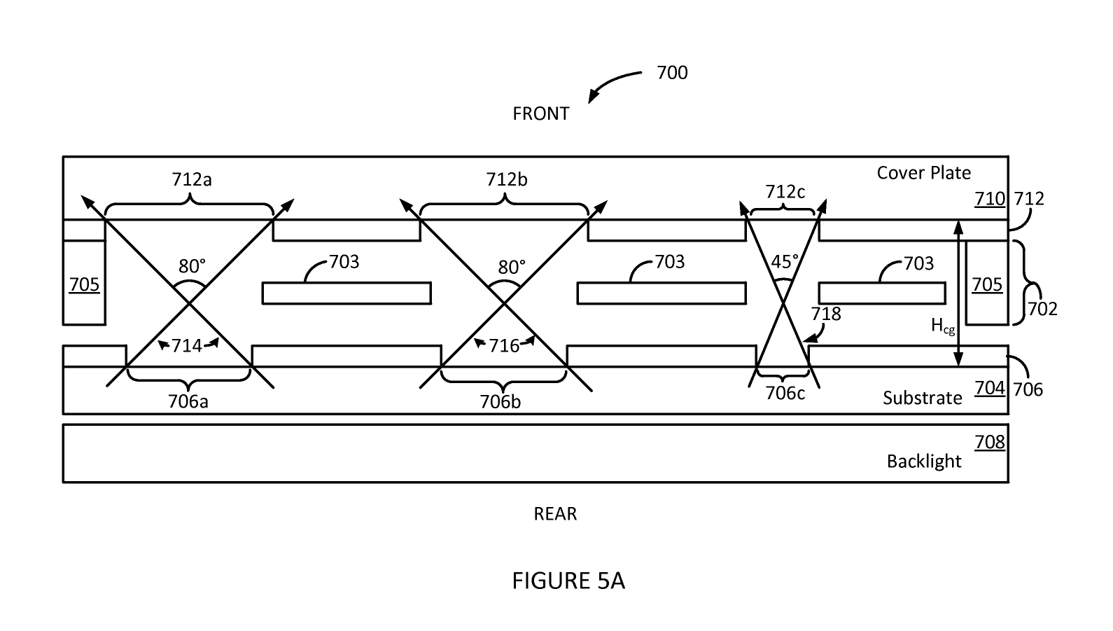

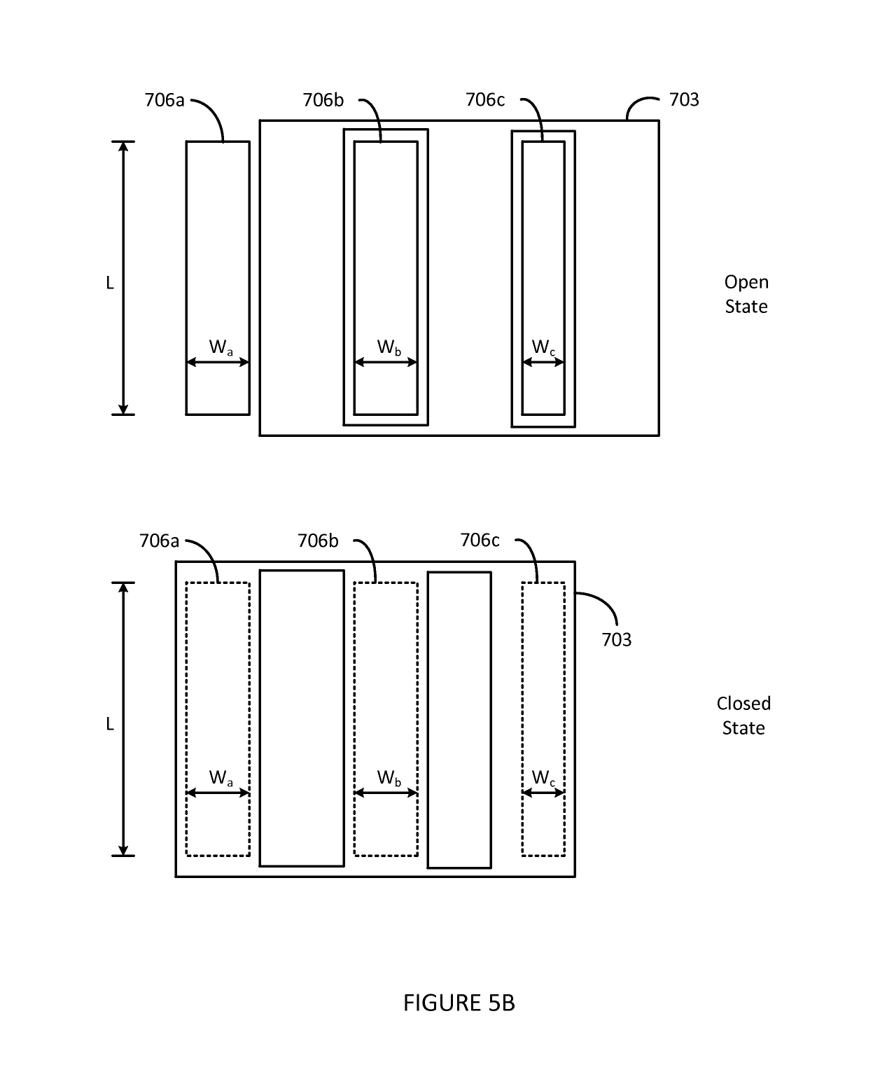

FIGS. 3-5B show various views of example display apparatus. In particular, FIG. 3 shows a cross-sectional view of a display apparatus 500 incorporating symmetric apertures, FIGS. 4A and 5A show cross-sectional views of example display apparatuses (500 and 600, respectively) incorporating asymmetric apertures, and FIGS. 4B and 5B show top views of the example display apparatuses shown in FIGS. 4A and 5A, respectively.

The display apparatus 500 of FIG. 3 incorporates a shutter-based light modulator (shutter assembly) 502. Although FIG. 3 shows only one shutter assembly 502, the display apparatus 500 can include an array of shutter assemblies 502 arranged in multiple rows and multiple columns. In some implementations, the dual actuator shutter assembly 400 discussed above in relation to FIGS. 2A and 2B can be used as the shutter assembly 502. Each shutter assembly 502 incorporates a shutter 503 and anchors 505. Not shown are compliant beam actuators which, when connected between the anchors 505 and the shutter 503, help to suspend the shutter 503 a short distance above an aperture layer. The shutter assembly 502 is disposed on a transparent substrate 504, such as a substrate made of plastic or glass. Display apparatus configurations in which the shutter assembly 502 is disposed on the substrate 504 are referred to as MEMS-up configurations. An aperture layer 506 is disposed on the substrate 504 and defines a plurality of evenly sized apertures: a first aperture layer aperture (“first AL aperture”) 506a and a second aperture layer aperture (“second AL aperture”) 506b. In some implementations, these apertures can have oblong shapes, such as rectangles, similar to the apertures 409 shown in FIGS. 2A and 2B. While the aperture layer 506 in FIG. 3 has only two apertures, it is understood that in some implementations the aperture layer 506 may have more than two apertures.

The aperture layer 506 can be made of or include a rear facing light reflecting film that reflects light not passing through the first AL aperture 506a or the second AL aperture 506b back towards the rear of the display apparatus 500. In some implementations, the front facing surface of the aperture layer 506 can include light absorbing material for improving contrast of the image displayed by the display apparatus 500. A vertical gap, which separates the shutters 503 from the aperture layer 506, can have a range of about 0.5 to 10 microns. In some implementations, the size of the vertical gap is less than the lateral overlap between the edge of shutters 503 and the edge of apertures 506a and 506b in the closed state, such as the overlap 416 depicted in FIG. 2B.

The display apparatus 500 can also include a backlight 508 for providing substantially even illumination throughout the display apparatus 500. The light from the backlight 508 can be modulated by the shutter assembly 502 based on image data. The backlight 508 can include one or more light sources for providing one or more colors (such as red, green, blue, white, etc.) of light and a light guide for uniformly distributing the light provided by the light sources.

A transparent cover plate 510 forms the front of the display apparatus 500. The rear side of the cover plate 510 can be covered with a light blocking layer 512 having two evenly sized apertures: a first light blocking layer aperture (“first LBL aperture”) 512a and a second light blocking layer aperture (“second LBL aperture”) 512b. In some implementations, these apertures can have oblong shapes, such as rectangles. The light blocking layer 512 blocks light received from the rear of the display apparatus 500 from passing through to the front of the display device 500, except at the apertures such as the first LBL aperture 512a and the second LBL aperture 512b. The light blocking layer can also be made of light absorbing material.

The first LBL aperture 512a and the second LBL aperture 512b are generally aligned with the first AL aperture 506a and the second AL aperture 506b, respectively. The shutter 503 moves laterally between the two sets of apertures, to block or pass light. For example, the shutter 503 in FIG. 3 is positioned such that light passing through the apertures in the aperture layer 506 is also allowed to pass substantially unobstructed through the apertures in the light blocking layer 512.

Light can pass through the first AL aperture 506a and the first LBL aperture 512a at various angles. The various angles with which the light emanates from the apertures are indicated by various arrows 520 shown in FIG. 3. The light emanating at various angles from the apertures produces an angular light distribution, which represents light emanating with various intensities at various angles from the apertures. It should be noted that FIG. 3 shows the angular light distribution only in the plane of the cross-section through the shortest dimension of the apertures 506a and 512a. It is understood that planes across other portions of the apertures 506a and 512a or at other orientations with respect to the apertures 506a and 512a may produce different angular light distributions.

In some implementations, it is desirable to have as wide an angular light distribution as possible. This is because a wider angular light distribution may result in a larger viewing angle for the display apparatus 500. The breadth of the angular distribution can be described in terms of a light distribution boundary angle defined by the largest angle that can be formed between the light rays passing through the aperture 512a in the relevant plane. For example, FIG. 3 shows the boundaries of the angular light distribution associated with the apertures 506a and 512a represented by a first set of light rays 514. The angle formed between the first set of light rays 514 can represent the light distribution boundary angle for the apertures 506a and 512a.

The cover plate 510 is separated from the substrate 504 by a distance known as a cell gap (indicated by H_{cg}). The light distribution boundary angle of the light passing through the apertures 506a and 512a is a function, in part, of the cell gap. The light distribution boundary angle can also be a function of the size of the apertures in the aperture layer 506, the shutter 503 and the light blocking layer 512. In some implementations, the size of the aperture in the shutter 503 is larger than the sizes of the apertures 506a and 512a so as to not impact the angular light distribution of the light emanating from the apertures 506a and 512a. In such implementations, the light distribution boundary angle may not be a function of the aperture size in the shutter 503. In some implementations, the light distribution boundary angle “α” can be represented by the expression: α=2 tan⁻¹ (average aperture size/cell gap); where the average aperture size is the average of the sizes of the apertures 506a and 512a in the plane in which the angular light distribution is determined. As discussed above, in some implementations, the angular distribution shown in FIG. 3 can be along the shortest dimension of the apertures 506a and 512a. In such implementations, the average aperture size can be the average of the shortest dimensions of the apertures 506a and 512a. As an example, the light distribution boundary angle formed by the first set of light rays 514 can be 70°.

Generally, for a given cell gap, apertures of the same size and shape will have similar angular light distribution characteristics. For example, referring to FIG. 3, if the sizes and shapes of the second AL aperture 506b and the second LBL aperture 512b are substantially similar to the sizes and shapes of the first AL aperture 506a and the first LBL aperture 512a, respectively, then the angular light distribution associated with the apertures 506b and 512b can be similar to that of the apertures 506a and 512a. Thus, a light distribution boundary angle for the apertures 506b and 512b, represented by the second set of light rays 516 can be similar to the light distribution boundary angle α for the apertures 506a and 512a, discussed above. Also as an example, the light distribution boundary angle formed by the second set of rays 516 is shown as 70°.

In some implementations, the light distribution boundary angle of 70° may be undesirably narrow. The narrow light distribution boundary angle may be a result of a reduction in the widths of the apertures in the aperture layer 506 and the light blocking layer 512, which, in turn, may have been reduced to accommodate a higher pixel-per-inch (PPI) specification for the display apparatus 500. One approach to improving the light distribution boundary angle can be to configure the display apparatus to include only a single, wider AL-LBL aperture pair for each display element. The increased widths can improve the angular distribution of light passing through the display element, which, in turn, can improve the viewing angle of the display apparatus. However, the increased aperture widths may also increase the distance that a shutter may have to travel relative to the apertures to switch between an open state and a closed state. Increasing the distance traveled by the shutter may decrease the speed of operation of the shutter as well as require the allocation of additional space for each display element. While neither of these outcomes is desirable, the latter is particularly problematic with respect to achieving a higher PPI display.

In contrast, in some implementations, as discussed below in relation to FIGS. 4A-5B, a display apparatus can provide improved angular light distribution by including multiple apertures of unequal or asymmetric widths in each display element. The width of at least one of the apertures is configured to be wide enough to provide a desired light distribution boundary angle, while still being small enough to limit the associated travel distance of the shutter to within acceptable limits.

FIG. 4A shows a cross-sectional view of an example display apparatus 600 having asymmetric apertures. In particular, the display apparatus 600 includes an aperture layer 606 having a first asymmetric AL aperture 606a that is approximately twice as wide as the second asymmetric AL aperture 606b. In addition, the display apparatus 600 includes a light blocking layer 612 having a first asymmetric LBL aperture 612a that is approximately twice as wide as the second asymmetric LBL aperture 612b. As discussed below, the asymmetric apertures of the display apparatus 600 provide improved light distribution boundary angles, and therefore a broader angular light distribution, for the light emitted by the display apparatus 600.

The display apparatus 600 includes a transparent substrate 604, such as a substrate made of plastic or glass. The display apparatus 600 also includes a backlight 608 for providing substantially uniform illumination. A transparent cover plate 610 is disposed towards the front of the display apparatus 600. The substrate 604, the backlight 608 and the cover plate 610 can be similar to the substrate 504, the backlight 508, and the cover plate 510, respectively, discussed above in relation to FIG. 3.

The aperture layer 606 is disposed over the front facing side of the substrate 604. Similar to the aperture plate 506 shown in FIG. 3, the aperture plate 604 of FIG. 4A can also include a rear facing light reflecting film. However, unlike the evenly sized first AL aperture 506a and second AL aperture 506b (as shown in FIG. 3), the first asymmetric AL aperture 606a and the second asymmetric AL aperture 606b are of different sizes. In particular, for apertures that are rectangular in shape, the size of the shorter side of the first asymmetric AL aperture 606a can be twice the size of the shorter side of the second asymmetric AL aperture 606b. But the sizes of the longer sides of the first asymmetric AL aperture 606a and the second asymmetric AL aperture 606b can be substantially similar. It should be understood that these dimensional relationships are only examples. In some implementations, the shorter side of the first asymmetric AL aperture 606a can be 25% greater than the shorter side of the second asymmetric AL aperture 606b. In some other implementations, the shorter side of the first asymmetric AL aperture 606a can be between about 25% to about 100% greater than the shorter side of the second asymmetric AL aperture 606b. Generally, various relative dimensions of the first asymmetric AL aperture 606a and the second asymmetric AL aperture 606b may be selected based upon the required angular light distribution characteristics.

The display apparatus 600 also includes the light blocking layer 612 on the rear facing side of the cover plate 610. Similar to the light blocking layer 510 shown in FIG. 3, the light blocking layer 612 shown in FIG. 4A can also be made of a light absorbing material. However, unlike the evenly sized first LBL aperture 512a and the second LBL aperture 512b, the first asymmetric LBL aperture 612a and a second asymmetric LBL aperture 612b are of different sizes. In particular, for apertures that are configured to be similar to the rectangular shaped apertures in the aperture layer 606, the size of the shorter side of the first asymmetric LBL aperture 612a can be twice the size of the shorter side of the second asymmetric LBL aperture 612b. But the sizes of the longer sides of the first asymmetric LBL aperture 612a and the second asymmetric LBL aperture 612b can be substantially similar. It should be understood that these dimensions are only examples. Generally, various relative dimensions of the first asymmetric LBL aperture 612a and the second asymmetric LBL aperture 612b may be selected to correspond to the aperture layer 606 apertures based on the required angular light distribution characteristics.

The display apparatus 600 also includes a dual actuator shutter assembly 602 having a shutter 603 supported by anchors 605. In some implementations, the shutter assembly 602 has an architecture similar to that shown in FIGS. 2A and 2B. The anchors 605 can be similar to the anchors 505 discussed above in relation to FIG. 3. Furthermore, the shutters 603 can also be similar to the shutters 503 shown in FIG. 3, except, that the light blocking portions of the shutter 603 can be sized based on the sizes of the apertures 606a and 606b in the aperture layer 606. The shutter 603 is shown in an open state, in which it allows light passing through the first asymmetric AL aperture 606a and the second asymmetric AL aperture 606b to pass through towards the front of the display apparatus 600. In the closed state, the shutter 603 is positioned in a manner that substantially blocks light from passing through towards the front of the display apparatus 600.

In some implementations, the first asymmetric AL aperture 606a and the first asymmetric LBL aperture 612a can be wider (i.e., greater along the shorter side of the rectangular shape) than the first AL aperture 506a and the first LBL aperture 512a (as shown in FIG. 3), respectively. Furthermore, the second asymmetric AL aperture 606b and the second asymmetric LBL aperture 612b can be narrower (i.e., smaller along the shorter side of the rectangular shape) than the second AL aperture 506b and the second LBL aperture 512b, respectively.

FIG. 4B shows a top view of the shutter 603 and the apertures 606a and 606b in the aperture layer 606 of the display apparatus 600 shown in FIG. 4A. In particular, FIG. 4B shows the positions of shutter 603 in an open state and a closed state over the asymmetric apertures: the first asymmetric AL aperture 606a and the second asymmetric AL aperture 606b. The first asymmetric AL aperture 606a has a width Wₐ that is greater than the width W_{b} of the second asymmetric AL aperture 606b. In some implementations, as the one shown in FIG. 4B, the length L of both the first asymmetric AL aperture 606a and the second asymmetric AL aperture 606b can be the same. The sizes of the slots in the shutter 603 are configured to be slightly larger than the corresponding aperture in the aperture layer 606.

In some implementations, the total width and area across the apertures 606a and 606b in the aperture layer 606 of FIG. 4A can be substantially equal to the total width and area across the apertures 506a and 506b in the aperture layer 506 of FIG. 3. Thus, even though the apertures 606a and 606b in the aperture layer 606 and the light blocking layer 612 are individually different in size from the apertures in the aperture layer 505 and the light blocking layer 512, the amount of light output by the display apparatus 600 of FIG. 4A can be substantially the same as the light output by the display apparatus 500 of FIG. 3.

The wider first asymmetric AL aperture 606a and the first asymmetric LBL aperture 612a can result in wider angular light distribution. For example, as shown in FIG. 4A, the first set of light rays 614 has a light distribution boundary angle of approximately 80°, which is 10° greater than the light distribution boundary angle of the first set of light rays 514 passing through the first AL aperture 506a and the first LBL aperture 512a (as shown in FIG. 3).

The narrower second asymmetric AL aperture 606b and the second asymmetric LBL aperture 612b can result in a smaller angular light distribution through the second asymmetric LBL aperture 612b. For example, as shown in FIG. 4A, the second set of light rays 616 have a light distribution boundary angle of approximately 45°, which is 25° less than the light distribution boundary angle of the second set of light rays 516 passing through the second AL aperture 506b and the second LBL aperture 512b (as shown in FIG. 3).

Despite the fact that the light distribution boundary angle of the second set of light rays 616 is smaller than the light distribution boundary angle of the first set of light rays 614, a greater percentage of the light output of the display apparatus 600 is passed through with a wider angular light distribution. Thus, the overall perceived angular light distribution of the display apparatus 600 is improved. Moreover, because of a wider angular distribution, the display apparatus 600 allows light to pass at angles (such as angles greater than 70°) beyond what can be allowed by the display apparatus 500 of FIG. 3.

The largest width Wₐ of the first set of apertures 606a and 612a of the display apparatus 600 of FIG. 4A is configured such that the resulting distance traveled by the shutter 603, and the resulting speed of operation of the shutter 603, is within desired bounds. In this manner, the display apparatus 600 provide improved angular light distribution for a specified shutter 603 operation speed.

Furthermore, the asymmetric configuration of the display apparatus 600 of FIG. 4A provides improved light leakage characteristics when the shutter 603 is in the closed state in comparison to that provided by the equal sized apertures of the display apparatus 500.

In some implementations, as additional space is made available per pixel, the width of the smaller AL and LBL apertures 606b and 612b can be increased up to the width of the wider AL and LBL apertures 606a and 612a. If still additional space is made available, the width of both the AL and both LBL apertures can be increased equally to provide a wider angular light distribution. However, as mentioned above, larger apertures may also increase the distance the shutter 603 may have to travel to move between an open state and a closed state. Increasing in the distance traveled by the shutter 603 may, in turn, increase the actuation voltages for operating the shutter 603 and may also decrease the speed of operation of the shutter 603.

Instead, as discussed further below with reference to FIG. 5A, instead of continuously, equally increasing the widths of the apertures to occupy the entire additional available space, it may be advantageous to limit the widths of the apertures to within a range of widths that results in acceptable shutter travel distances. In other words, the widths of the apertures may be increased equally only up to a size beyond which the corresponding travel of the shutter would become unacceptable. Any additional space that is still available can then be utilized by adding additional narrower apertures.

FIG. 5A shows a cross-sectional view of another example display apparatus 700 incorporating asymmetric apertures. In particular, the shutter assembly 700 includes an aperture layer 706 having a first asymmetric AL aperture 706a, a second asymmetric AL aperture 706b and a third asymmetric AL aperture 706c, where the third asymmetric AL aperture 706c is narrower than the other two asymmetric AL apertures. Furthermore, the display apparatus 700 also includes a light blocking layer 712 having a first asymmetric LBL aperture 712a, a second asymmetric LBL aperture 712b and a third asymmetric LBL aperture 712c, where the third asymmetric LBL aperture 712c is narrower than the other two asymmetric LBL apertures.

The display apparatus 700 includes a transparent substrate 704, such as a substrate made of plastic or glass. The display apparatus 700 also includes a backlight 708 for providing uniform illumination. A transparent cover plate 710 is disposed towards the front of the display apparatus 700. The substrate 704, the backlight 708 and the cover plate 710 can be similar to the substrates 504 and 604, the backlights 508 and 608, and the cover plates 510 and 610 discussed above in relation to FIGS. 3 and 4A, respectively. Furthermore, aperture layer 706 and the light blocking layer 712 can be made of light absorbing material similar to the aperture layer 506 and 606 and light blocking layers 512 and 712 discussed above in relation to FIGS. 3 and 4A, respectively.

The display apparatus 700 also includes a shutter assembly 702 having a shutter 703 and anchors 705. Unlike the MEMS-up configured shutter assembly 502 shown in FIG. 3, which is built on the substrate 504, the shutter assembly 702 shown in FIG. 5A is built on the cover plate 710 (i.e., in a configuration referred to as MEMS-down configuration). The shutter 703 is shown in an open state, in which it allows light passing through the first asymmetric AL aperture 706a, the second asymmetric AL aperture 706b and the third asymmetric AL aperture 706c to pass through towards the first asymmetric LBL aperture 712a, the second asymmetric LBL aperture 712b and the third asymmetric LBL aperture 712c, respectively. In the closed state, the shutter 703 is moved such that it blocks substantially all light passing through the apertures in the aperture layer 706 from reaching the apertures in the light blocking layer.

FIG. 5A shows a first set of light rays 714 passing through the first asymmetric AL aperture 706a and the first asymmetric LBL aperture 712a, a second set of light rays 716 passing through the second asymmetric AL aperture 706b and the second asymmetric LBL aperture 712b and a third set of light rays 718 passing through the third asymmetric AL aperture 706c and the third asymmetric LBL aperture 712c. The widths of the first asymmetric AL aperture 706a and the first asymmetric LBL aperture 712a are substantially the same as the widths of the second asymmetric AL aperture 706b and the second asymmetric LBL aperture 712b. Therefore, the light distribution boundary angle and the corresponding angular light distribution of the first set of light rays 714 will be substantially equal to the light distribution boundary angle and the corresponding angular light distribution of the second set of light rays 716. In the example shown in FIG. 5A, the light distribution boundary angle of the first set of light rays and the second set of light rays is equal to 80°.

FIG. 5B shows a top view of the shutter 703 and the apertures in the aperture layer 706 of the display apparatus 700 shown in FIG. 5A. In particular, FIG. 5B shows the positions of shutter 703 in an open state and a closed state over the asymmetric apertures: the first asymmetric AL aperture 706a, the second asymmetric AL aperture 706b, and the third asymmetric AL aperture 706c. The first asymmetric AL aperture 706a and the second asymmetric AL aperture 706b each have equal widths Wₐ and W_{b} respectively. However, the widths Wₐ and W_{b} are greater than the width W_{c} of the third asymmetric AL aperture 706c. In some implementations, as the one shown in FIG. 5B, the length L of all the apertures in the aperture layer 706 can be the same. The sizes of the slots in the shutter 703 are configured to be slightly larger than the corresponding aperture in the aperture layer 706.

As mentioned above, the third asymmetric AL aperture 706c and the third asymmetric LBL aperture 712c are narrower than the other apertures on the aperture layer 706 and the light blocking layer 712, respectively. As a result, a third set of light rays 718 passing through the third asymmetric AL aperture 706c and the third asymmetric LBL aperture 712c can have a smaller light distribution boundary angle. As an example, the third set of light rays 718 has a light distribution boundary angle of 45°. However, because a greater percentage of the light output of the display apparatus 700 is included in the first set of light rays 714 and the second set of light rays 716, the overall perceived angular light distribution of the display apparatus 700 is improved. Furthermore, the widths Wₐ and W_{b} are configured such that the resulting shutter 703 travel and the resulting operation speed of the shutter 703 are within the desired limits. As discussed above, in some implementations, as additional space is made available per pixel, the width of the apertures, such as the first AL aperture 506a and the first LBL aperture 512a (as shown in FIG. 3), can be increased equally to provide a wider angular light distribution. However, by including a third asymmetric set of apertures 706c and 712c and asymmetrically configuring the other two sets of apertures (706a-712a and 706b-712b) as shown in FIGS. 5A and 5B, the operating speed of the shutter can be retained within acceptable limits while improving the light blocking characteristics of the shutter as compared to that of shutters having two wider equal sized apertures.

In some implementations, the narrowest apertures, for example, the third asymmetric AL 706c and the third asymmetric LBL aperture 712c can be placed between the other two sets of wider apertures.

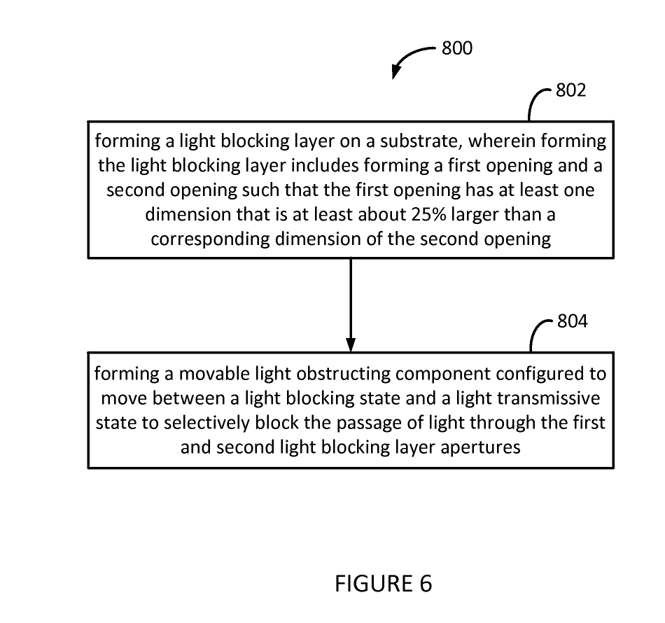

FIG. 6 shows a flow diagram for an example process 800 for forming a display apparatus having asymmetrical apertures. In particular, the process 800 includes forming a light blocking layer on a substrate, where forming the light blocking layer includes forming a first aperture and a second aperture such that the first aperture has at least one dimension that is at least about 25% larger than a corresponding dimension of the second aperture (stage 802). The process 800 also includes forming a movable light obstructing component configured to move between a light blocking state and a light transmissive state to selectively block the passage of light through the first and second apertures (stage 804).

The process 800 begins with forming the light blocking layer on the substrate, wherein forming the light blocking layer includes forming a first aperture and a second aperture such that the first aperture has at least one dimension that is at least about 25% larger than a corresponding dimension of the second aperture (stage 802). One example of the result of this process stage is discussed above in relation to FIG. 4A. In particular, FIG. 4A shows an aperture layer 606 having a first asymmetric AL aperture 606a having a width that is approximately 25% greater than the width of a second asymmetric AL aperture 606b.

The process 800 also includes forming a movable light obstructing component configured to move between a light blocking state and a light transmissive state to selectively block the passage of light emanating from the first and second apertures (stage 804). One example of the result of this process stage 804 is discussed above in relation to FIG. 4A. In particular, FIG. 4A shows a shutter 603 that can be selectively moved between an open state and a closed state. In the open state the shutter 603 allows light to pass light emanating from the first asymmetric AL aperture 606a and the second asymmetric AL aperture 606b. As also described in relation to FIG. 4A, the shutter 603 can be selectively moved to a closed state such that it blocks light emanating from the first asymmetric AL aperture 606a and the second asymmetric AL aperture 606b. One of skill in the art would appreciate that the asymmetric apertures can be adopted in a display apparatus having a MEMS-up configuration or a display apparatus having a MEMS-down configuration.

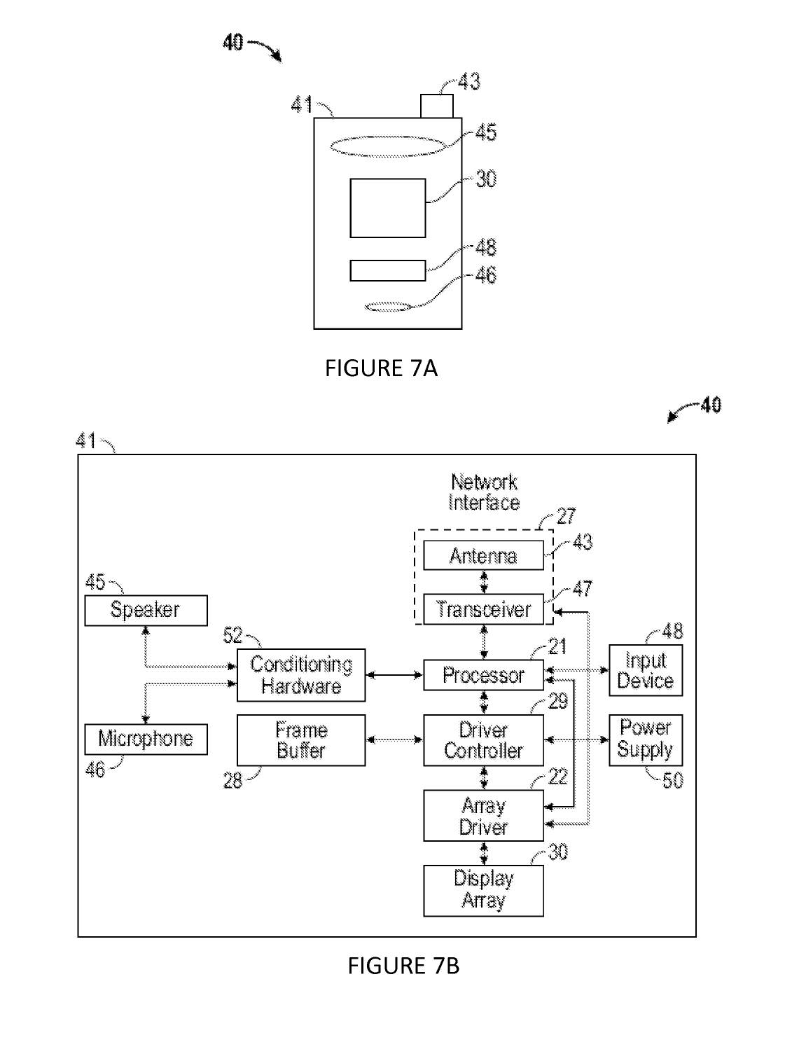

FIGS. 7A and 7B show system block of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 7B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 7A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The general purpose processor may be a microprocessor, or, any conventional processor, controller, microcontroller, or state machine. The processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. The storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus having an electromechanical systems (EMS) display element, comprising:
a light blocking layer defining at least first and second light blocking layer apertures, wherein the first light blocking layer aperture has at least one dimension that is at least about 25% larger than a corresponding dimension of the second light blocking layer aperture; and
a light obstructing component supported over the light blocking layer configured to move between a light blocking state and a light transmissive state to selectively block the passage of light through the first and second light blocking layer apertures.

2. The apparatus of claim 1, wherein the light obstructing component defines a light obstructing component aperture such that when the light obstructing component is in the light transmissive state, the light obstructing component aperture substantially aligns with at least one of the first and second light blocking layer apertures.

3. The apparatus of claim 1, wherein the light blocking layer defines at least a third light blocking layer aperture and the light obstructing component is configured, in the light blocking state, to block the passage of light through the at least third light blocking layer aperture.

4. The apparatus of claim 3, wherein at least third light blocking layer aperture has dimensions substantially the same as the first light blocking layer aperture.

5. The apparatus of claim 4, wherein the first, second, and at least third light blocking layer apertures are arranged substantially in a line along an axis of motion of the light obstructing component; and wherein the second light blocking layer aperture is positioned at one end of the line.

6. The apparatus of claim 5, wherein the at least one dimension of the first light blocking layer aperture that is at least 25% larger than the corresponding dimension of the second light blocking layer aperture is a dimension along the axis of motion of the light obstructing component.

7. The apparatus of claim 1, wherein at least one dimension of the first light blocking layer aperture is about 100% larger than the corresponding dimension of the second light blocking layer aperture.

8. The apparatus of claim 1, further comprising:
a display including the EMS display element;
a processor that is configured to communicate with the display, the processor being configured to process image data; and
a memory device that is configured to communicate with the processor.

9. The apparatus of claim 8, the display further including:
a driver circuit configured to send at least one signal to the display; and
a controller configured to send at least a portion of the image data to the driver circuit.

10. The apparatus of claim 8, the display further including:
an image source module configured to send the image data to the processor, wherein the image source module comprises at least one of a receiver, transceiver, and transmitter.

11. The apparatus of claim 8, the display further including:
an input device configured to receive input data and to communicate the input data to the processor.

12. A method for forming a display apparatus, the method comprising:
forming a light blocking layer on a substrate, wherein forming the light blocking layer includes forming a first aperture and a second aperture such that the first aperture has at least one dimension that is at least about 25% larger than a corresponding dimension of the second aperture; and
forming a movable light obstructing component configured to move between a light blocking state and a light transmissive state to selectively block the passage of light through the first and second apertures.

13. The method of claim 12, wherein forming the movable light obstructing component includes defining a light obstructing component aperture such that when the light obstructing component is in the light transmissive state, the light obstructing component aperture substantially aligns with at least one of the first and second apertures.

14. The method of claim 13, wherein forming the light blocking layer further includes forming a third aperture having dimensions substantially the same as the dimensions of the first aperture.

15. The method of claim 14, wherein forming the light blocking layer further includes arranging the first, second and the third aperture substantially in a line along an axis of motion of the light obstructing component.

16. The method of claim 15, wherein forming the light blocking layer further includes forming the first and the second apertures such that at least one dimension of the first aperture that is along the axis of motion of the light obstructing component is at least 25% larger than the corresponding dimension of the second aperture.

17. The method of claim 12, wherein forming the light blocking layer further includes forming the first and second apertures such that the dimensions of the first aperture are 100% larger than the corresponding dimensions of the second aperture.
